(19) United States
(12) Patent Application Publication
(10) Pub. No.: US 2024/0240667 A1
(43) Pub. Date: Jul. 18, 2024

(54) MODULAR RADIAL FOIL BEARING HAVING AN ELASTIC CARRIER FOIL

(71) Applicant: Schaeffler Technologies AG & Co. KG, Herzogenaurach (DE)

(72) Inventors: Jürgen Hilbinger, Neustadt/A. (DE); Andre Anger, Uehlfeld (DE); Hermann Geyer, Vestenbergsgreuth (DE)

(73) Assignee: Schaeffler Technologies AG & Co. KG, Herzogenaurach (DE)

(21) Appl. No.: 18/562,526

(22) PCT Filed: Mar. 25, 2022
(86) PCT No.: PCT/DE2022/100228

§ 371 Date: Nov. 20, 2023

(30) Foreign Application Priority Data
May 25, 2021 (DE) 10 2021 113 397.1

(51) Int. Cl. F16C 17/02

(52) U.S. Cl. CPC F16C 17/024

(57) ABSTRACT

A radial foil bearing includes a carrier foil formed from a corrugated foil, a first curved segment formed from a first top foil and a second curved segment formed from a second top foil. The second curved segment is arranged successively on the carrier foil after the first curved segment to form a tubular carrier comprising two curved segments when the carrier foil is rolled. In an embodiment, the carrier foil has a first end and a second end, and, after the carrier foil is rolled to form the tubular carrier, the tubular carrier has a circumferentially closed shape and the first end faces the second end.

### CROSS-REFERENCE TO RELATED APPLICATIONS

This application is the United States National Phase of PCT Appln. No. PCT/DE2022/100228 filed Mar. 25, 2022, which claims priority to German Application No. DE102021113397.1 filed May 25, 2021, the entire disclosures of which are incorporated by reference herein.

### TECHNICAL FIELD

The present disclosure relates to a radial foil bearing, and more specifically to a modular radial foil bearing having an elastic carrier foil.

### BACKGROUND

Radial foil bearings are intended for the aerodynamic supporting of shafts, wherein a supporting gas/air cushion is formed between the shaft and the radial foil bearing. The mode of operation is similar to that of a hydrodynamic plain bearing, but with the difference that the shaft is supported by the radial foil bearing via an air cushion and not by a fluid cushion of a hydrodynamic fluid bearing. Both functional forms have in common that only the rotational motion of the shaft leads to the formation of the supporting cushion.

Foil bearings differ from conventional aerodynamic bearings by virtue of a flexible, elastic structure between the rotating shaft and the stationary housing component. This feature means that although they have a lower stiffness than conventional air bearings, they can adapt to geometric changes in the air gap caused, for example, by misalignment errors of the bearing seats or differing thermal expansion of the shaft and housing, thus enabling higher operational reliability in practice in many applications.

To form the supporting air cushion, the radial foil bearing usually has a top foil in contact with the stationary shaft and a corrugated foil arranged radially between the top foil and the outer ring of the bearing, which can elastically deflect in the radial direction. Thus, in principle, the radial foil bearing has two foils in contact with one another and an outer ring supporting the foils so that the radial foil bearing can be received in a housing. The outer ring can also be formed integrally with the housing, in which the foils of the radial foil bearing are inserted.

If the shaft is set in rotational motion relative to the radial foil bearing, the air present in the air gap defined by standstill is displaced. Above a certain speed of the shaft, an air cushion forms between the top foil and the shaft on which the shaft can slide. In this regard, the foil arrangement with its corrugated foil and radial spring effect ensures that fluctuations in air pressure or vibrations of the shaft in the radial direction do not adversely affect the bearing and thus keep the air cushion load-bearing.

In the prior art, a variety of designs of foil bearings are known. In addition to radial foil bearings, there are also axial foil bearings that can provide an axial load-bearing capacity. The arrangement of the foils of the bearing as well as their geometric design are diverse and adapted to each application.

EP 2 942 537 A1 shows a radial foil bearing with three corrugated foils and an almost circumferential top foil, wherein the corrugated foils are each hooked with a hook-shaped end into their own slot in the outer ring and the top foil is inserted into one of the slots with both ends bearing against one another.

EP 3 387 275 A1 shows a radial foil bearing with three arrangements consisting of a top foil and a corrugated foil, wherein each pack is inserted into a slot in the outer ring at each end of the foils.

CN 209 990 776 U shows a radial foil bearing in which both the corrugated foil and the top foil are designed to be almost completely circumferential and each have an angled end with which both foils are inserted into a common slot. This connection is then secured with a screw in a clamping manner.

EP 2 473 749 A1 shows a radial foil bearing with precisely one top foil and precisely one corrugated foil for forming the bearing in an outer ring.

It has proven problematic to arrange the foils economically in order to optimize the functional load-bearing capacity.

### SUMMARY

The present disclosure provides a radial foil bearing which permits an economical arrangement of the foils and improves the radial foil bearing with regard to its function.

The present disclosure provides a radial foil bearing, in which there is a first curved segment, consisting of a first top foil, with the first curved segment being fixedly arranged on a carrier foil, with a second curved segment, consisting of a second top foil, being arranged on the carrier foil, with the two curved segments being placed successively on said carrier foil, such that, when the carrier foil is rolled up, a tubular carrier with the two curved segments is produced and forms the radial foil bearing, with the carrier foil being designed as a corrugated foil and thus having a corrugated foil-like carrier foil and this corrugated shape having elasticity or flexibility.

The corrugated foil-like carrier foil may be formed from a thin (<0.5 mm) sheet metal strip made of stainless spring steel sheet, which can be bent into a circle by hand or using an auxiliary device.

The corrugated foil-like carrier foil is initially present as a flat strip, on which the curved segments made of a top foil are attached.

The curved segments are formed into an arch shape from a top foil. The curved segments are then placed successively on the corrugated foil-like carrier foil, with two successive curved segments being spaced apart from one another in such a way that, after the corrugated foil-like carrier foil has been rolled up to form the tubular carrier, one end of a curved segment overlaps the subsequent end of the subsequent curved segment either to a small extent or is adjacent or slightly spaced apart.

The corrugated foil-like carrier foil is wrapped around the curved segments, such that the corrugated foil-like carrier foil has enveloped and surrounds the curved segments. Thus, in the radial direction, the structure of abutting cover and corrugated foils occurs after the formation of the tubular carrier, with the corrugated foil being a single foil which envelops a plurality of curved top foils. The individual corrugated foil, designed as a corrugated foil-like carrier foil, encloses the top foils almost completely, with the tubular carrier being configured almost closed in the circumferential direction. After envelopment, the at least two top foils enclosed by the corrugated foil-like carrier foil form a bearing surface which is almost completely closed in the circumferential direction so that the shaft to be supported can always be supported during operation and does not suffer stalling due to any small circumferential spacing between two successive top foils.

The curved segments are directly and/or indirectly fixed, for example welded, at one end to the corrugated foil-like carrier foil.

In order to reliably place and attach the end of a curved segment to the corrugated foil-like carrier foil, the corrugated foil-like carrier foil has positioning means, for example in the form of a recess, which can be brought into contact or alignment with this end of the curved segment. The positioning means may be designed as a notch on the edge of the strip-like, corrugated foil-like carrier foil and is therefore easily accessible for a tool that aligns the curved segment with this positioning means.

Here, a radial foil bearing can be inserted as an assembly of curved segments and corrugated foil-like carrier foil directly into a bearing receiving bore, for example of a compressor housing, or as a self-retaining unit of curved segments and corrugated foil-like carrier foil is connected to a bearing outer ring sleeve, which can then be installed in the unit.

Thus, the radial foil bearing according to the disclosure can be used for oil-free and high-speed rotor bearing arrangements, for example in fuel cell compressors, eBoosters or turbochargers, with the design of the radial foil bearing according to the disclosure enabling cost-efficient large-scale production and also the modular structure to cover different requirements in terms of implementation the radial foil bearing in the unit assembly.

In an example embodiment of the disclosure, a third curved segment is formed with a third top foil, with three curved segments now being arranged successively on the corrugated foil-like carrier foil, such that, when the corrugated foil-like carrier foil is rolled up, the tubular carrier with the three curved segments is produced and forms the radial foil bearing. The use of three curved segments has the advantage that the shaft can be better centered during operation.

According to a further development, the number of curved segments and their successive arrangement on a corrugated foil-like carrier foil can be scaled or multiplied, i.e. a plurality of curved segments or groups of curved segments can be provided, which are fixedly placed successively on the carrier foil, such that, when the carrier foil is rolled up, the tubular carrier with the curved segments is produced and the radial foil bearing is formed.

In an example embodiment of the disclosure, after the corrugated foil-like carrier foil has been rolled up to form a tubular carrier with the curved segments, the tubular carrier has a circumferential (closed) shape, with the two ends of the corrugated foil-like carrier foil facing one another. The opposite ends of the corrugated foil-like carrier foil can
contact each other with their faces or
form an overlap in the radial direction or
have a small spacing of their end faces with respect to each other.

In cases in which the ends of the corrugated foil-like carrier foil contact or overlap, these ends may be fixedly connected to one another to form a closed annular carrier. If the closed annular carrier is present with fixedly connected ends, it can either be inserted into an outer ring or directly into a housing bore. If the ends of the annular carrier are not fixedly connected to one another, an installation or assembly aid may be required in order to insert the tubular carrier into an outer ring or directly into a housing bore.

The circumferential length of the corrugated foil-like carrier foil corresponds to at least 240° of the inner circumference of the receiving bore for the tubular carrier, whereby the corrugated foil-like carrier foil clings to the circular shape of the inner peripheral surface of the bearing seat bore/bearing outer ring sleeve after the tubular carrier has been inserted and is therefore designed to fit.

In an example embodiment of the disclosure, after the corrugated foil-like carrier foil has been rolled up to form a tubular carrier with the curved segments, the one end of the one curved segment is opposite the end of a subsequent curved segment. The opposite ends may contact each other or may be spaced apart. Two curved segments can also overlap. It is also possible for only one foil of the one curved segment to overlap with a foil of the other curved segment, such that these overlapping foils contact one another in the radial direction in the region of the overlap. The radial foil bearing or the tubular carrier can thus be more stable and more efficient.

The foil of a curved segment can overlap with the foil of a subsequent curved segment after the tubular carrier has been formed in such a way that the functionally required wedge gap towards the rotating shaft is formed in order to form the supporting air cushion. According to a further development of the disclosure, the annular carrier is inserted into an outer ring to form the radial foil bearing.

In this case, the outer ring can be a separate component which, with the tubular carrier, forms the radial foil bearing, which is then inserted into a housing. As an alternative to this, the outer ring can be formed by the housing itself, as a result of which the tubular carrier can be inserted to form the radial foil bearing.

The disclosure is such that at least the one degree of freedom in an axial direction of the tubular carrier which is placed in the outer ring is blocked. Both degrees of freedom may be blocked in both axial directions of the tubular carrier which is placed in the outer ring.

According to an example embodiment of the radial foil bearing according to the disclosure with an outer ring, a degree of freedom in the circumferential direction of the tubular carrier which is placed in the outer ring is blocked. Thus, the tubular carrier which is inserted into the outer ring can be welded to it so that a relative rotation between the tubular carrier and the outer ring is prevented.

### BRIEF DESCRIPTION OF THE DRAWINGS

Example embodiments of the disclosure are shown in the following drawings. In the drawings:

FIG. 1 shows a corrugated foil-like carrier foil with three curved segments attached to it;

FIG. 2 shows one of the curved segments according to FIG. 1;

FIG. 3 shows the corrugated foil-like carrier foil as a straight sheet metal strip from FIG. 1;

FIG. 4 shows a radial foil bearing according to the disclosure;

FIG. 5 shows an outer ring for receiving a tubular carrier;

FIG. 6 shows the outer ring according to FIG. 5 with the mounted tubular carrier;

FIG. 7 shows a section in the axial direction through the embodiment according to FIG. 6;

FIG. 8 shows the one axial end of the cut outer ring according to FIG. 7;

FIG. 9 shows the other axial end of the cut outer ring according to FIG. 7,

FIG. 10 shows a second variant of the outer ring with a mounted tubular carrier;

FIG. 11 shows the outer ring for receiving a tubular carrier according to FIG. 10;

FIG. 12 shows a section in the axial direction through the embodiment according to FIG. 10;

FIG. 13 shows a detailed view of one axial end of the cut outer ring according to FIG. 12;

FIG. 14 shows a detailed view of the other axial end of the cut outer ring according to FIG. 12;

FIG. 15 shows a detailed view of the radial foil bearing;

FIG. 16 shows a section in the axial direction through the embodiment according to FIG. 15;

FIG. 17 shows a detailed view of one axial end of the cut outer ring according to FIG. 15; and

FIG. 18 shows a detailed view of the other axial end of the cut outer ring according to FIG. 15.

### DETAILED DESCRIPTION

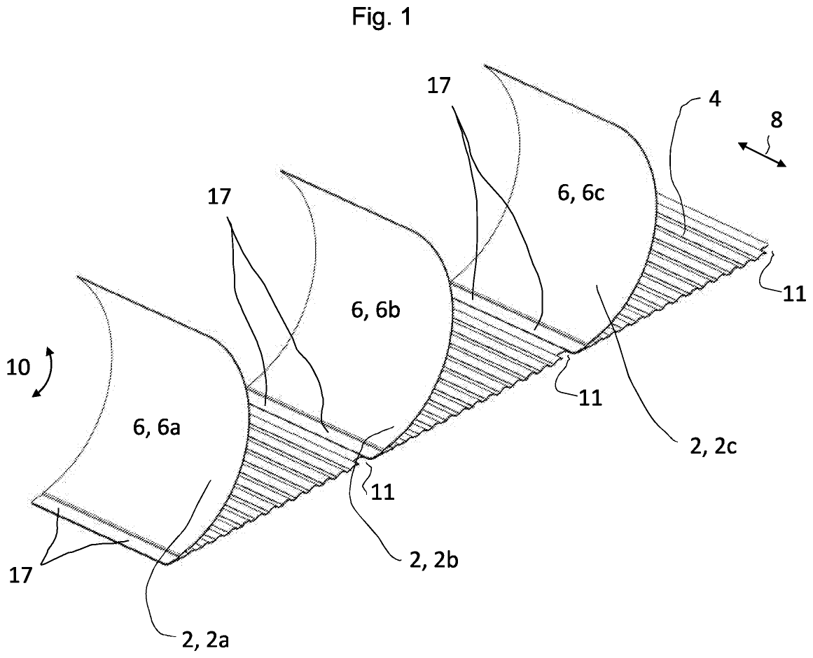

FIG. 1 shows a corrugated foil-like carrier foil 4 with three curved segments 6a, 6b, 6c attached to it. The corrugated foil-like carrier foil 4 is designed as a strip of material, in particular as a sheet metal strip, which has a maximum thickness of 0.5 mm. The strip-like, corrugated foil-like carrier foil 4 extends transverse to the subsequent axial direction 8, which is defined after the corrugated foil-like carrier foil 4 has been rolled up to form a tubular carrier. The corrugated foil-like carrier foil 4 has a plurality of recesses, in particular in the form of a notch 11, with which the curved segments 6 to be placed on the corrugated foil-like carrier foil 4 are to be aligned so that the curved segments 6 to be placed can be easily and reliably arranged at the correct distances from one another on the corrugated foil-like carrier foil 4 and then attached to the corrugated foil-like carrier foil 4.

In FIG. 1, three curved segments 6a, 6b, 6c are arranged successively and in a pattern on a corrugated foil-like carrier foil 4, such that the present pattern is largely regular and repeatable and all curved segments 6a, 6b, 6c have the same orientation on the corrugated foil-like carrier foil 4. Each curved segment 6a, 6b, 6c has an end to which the respective curved segment 6 on the corrugated foil-like carrier foil 4 is welded. This welding 17 of all components can occur together when the curved segments 6 are positioned on the corrugated foil-like carrier foil 4.

For the precise positioning of the curved segments 6a, 6b, 6c on the corrugated foil-like carrier foil 4, the curved segments 6a, 6b, 6c are each brought into congruence with a notch 11 in such a way that, for example, the end edge of a curved segment 6 is flush with an edge of the notch 11. The notches 11 are formed for a curved segment 6 on the opposite edges delimiting the strip-like corrugated foil-like carrier foil 4 and are present in pairs for a curved segment 6. The shape and position of such notches 11 can vary as positioning means, so such a positioning means can alternatively also be arranged within the strip-like corrugated foil-like carrier foil 4 and have a shape conducive to the positioning of a curved segment 6.

As can be seen from FIG. 1, the curved segments 6a, 6b, 6c are already bent before they are mounted on the flat, strip-like, corrugated foil-like carrier foil 4. The curved segments 6a, 6b, 6c form the respective top foils 2a, 2b and 2c.

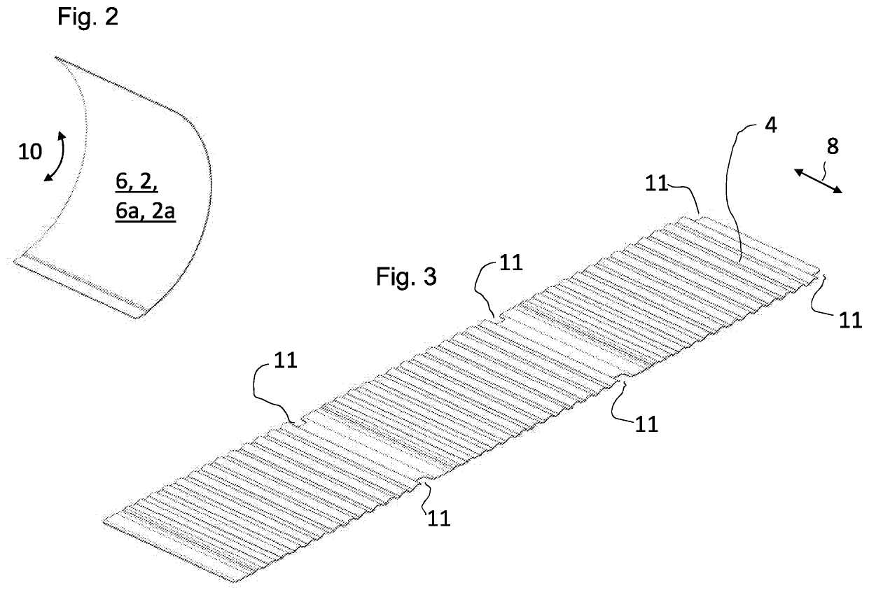

FIG. 2 shows a curved segment 6 or 6a made from a top foil 2 or 2a. A top foil 2 is formed by a curved segment 6, which then forms a nearly continuous top foil 2 in their plurality arranged successively in the circumferential direction. The design of the curved segment 6 already defines an axial direction 8 and a circumferential direction 10, which is transferred to the other assemblies.

FIG. 3 shows the corrugated foil-like carrier foil 4 as a straight sheet metal strip from FIG. 1. The notches 11 are arranged on the two opposite side edges of the corrugated foil-like carrier foil 4 and are placed at regular distances along the extension of the straight sheet metal strip. The notches 11 divide the corrugated foil-like carrier foil 4 into three corrugated portions, each of which will bear against a curved segment 6 designed as a top foil 2 after the tubular carrier 7 has been formed.

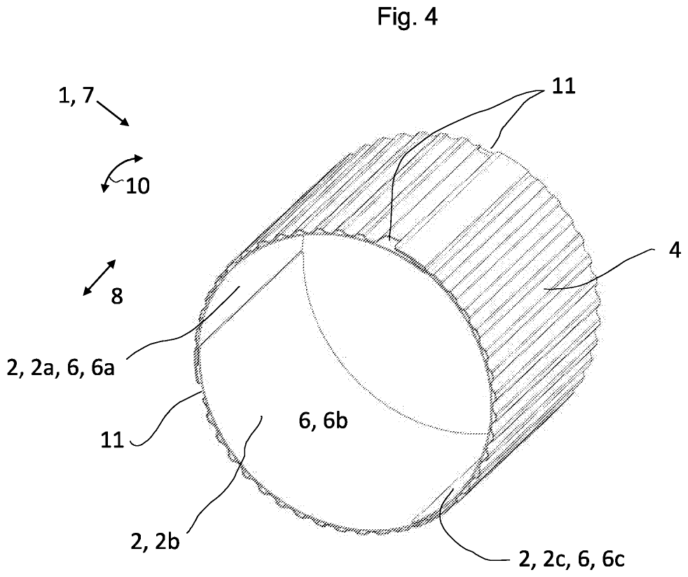

FIG. 4 shows a radial foil bearing 1. The radial foil bearing 1 is produced by rolling up the corrugated foil-like carrier foil 4 in the circumferential direction 10, the prepared arrangement of the corrugated foil-like carrier foil 4 with the curved segments 6a, 6b, 6c being present, for example according to FIG. 1. In FIG. 4 the radial foil bearing 1 is already present as a tubular carrier 7 and can be inserted into a receiving bore, adapted to the carrier 7, of a housing of a unit and operated there to support a shaft.

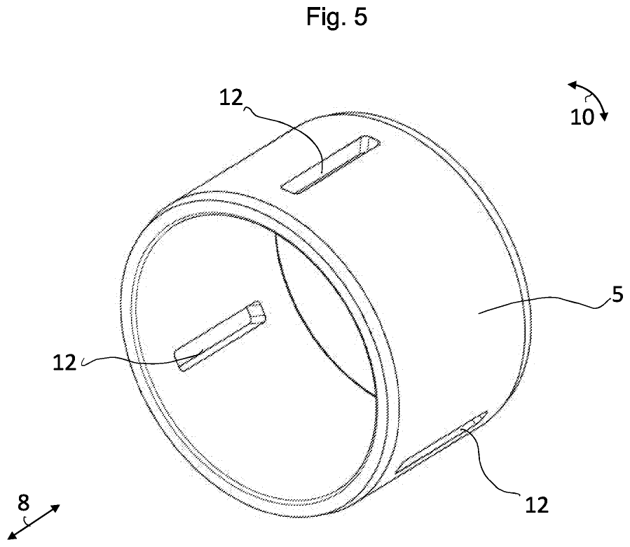

FIG. 5 shows an outer ring 5 for receiving a tubular carrier 7. The radial foil bearing 1 according to FIG. 4 in the form of the tubular carrier 7 can be enhanced by inserting it into an outer ring 5, with the sensitive foils 2 and 4 being able to be protected from external influences by the outer ring 5. The outer ring 5 may be designed as a deep-drawn sheet metal sleeve and, according to FIG. 5, is provided with slots 12 distributed in a regular manner in the circumferential direction 10. These slots 12 can easily be punched in a sheet metal sleeve and are provided for the accessibility of a tool for the tubular carrier 7. The slots 12 themselves extend exclusively in the axial direction 8.

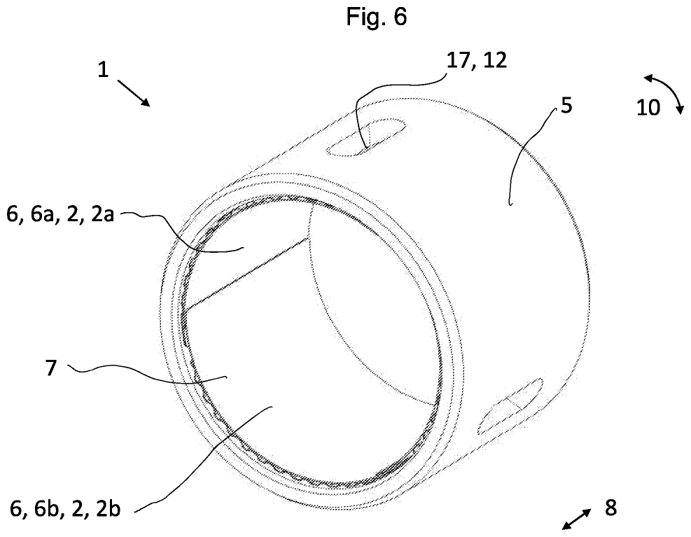

FIG. 6 shows the outer ring 5 according to FIG. 5 with the mounted tubular carrier 7. The tubular carrier 7, for example according to FIG. 4, has been inserted into the outer ring 5 according to FIG. 5. The axial length of the tubular carrier 7 corresponds to the axial length of the outer ring 5, whereby the carrier 7 is flush with the outer ring 5 at both axial ends. As an alternative to this, a small overhang may be provided, in the sense that the axial length of the outer ring 5 is greater than the axial length of the carrier 7, so that the edges of the foils 2 and 4 are better protected from impact points.

The slots 12 ensure the accessibility of a tool which can fixedly connect, e.g., weld, the carrier 7 to the outer ring 5, with the outer peripheral surface of the corrugated foil-like carrier foil 4 bearing against the inner peripheral surface of the outer ring 5.

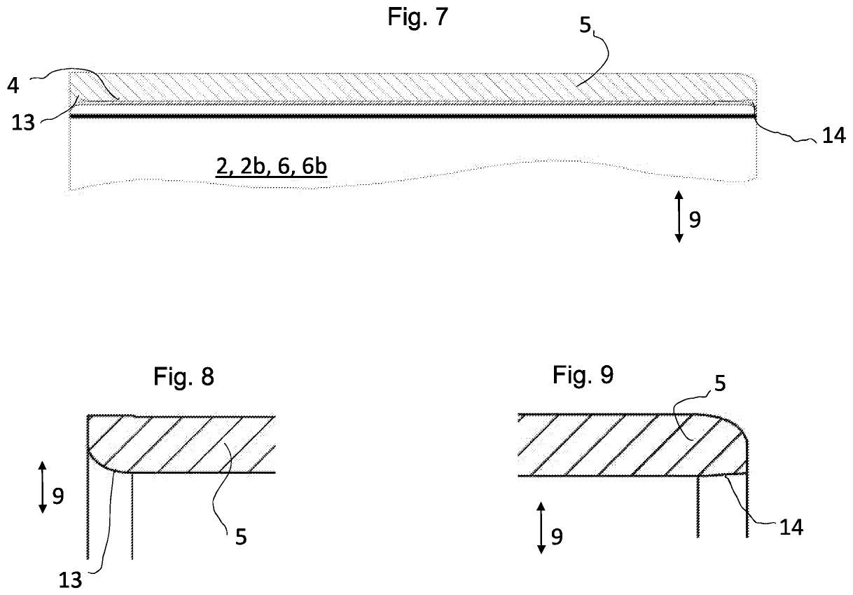

FIG. 7 shows a section in the axial direction 8 through the embodiment of FIG. 6. In this exemplary embodiment, the axial length of the carrier 7, and thus also the axial length of the curved segments 6a, 6b, 6c and of the corrugated foil-like carrier foil 4, corresponds to the axial length of the outer ring 5.

FIG. 8 shows one axial end of the cut outer ring 5 according to FIG. 7. The one axial end has a rounded portion 13 on the radial inner side of the outer ring 5, which is intended to facilitate the insertion of the carrier 7 into the outer ring 5.

FIG. 9 shows the other axial end of the cut outer ring 5 according to FIG. 7. This axial end has a chamfer 14 on the radial inner side of the outer ring 5, which is provided to prevent damage to the foils 2 and 4 during handling of the radial foil bearing 1 or during transport of the radial foil bearing 1.

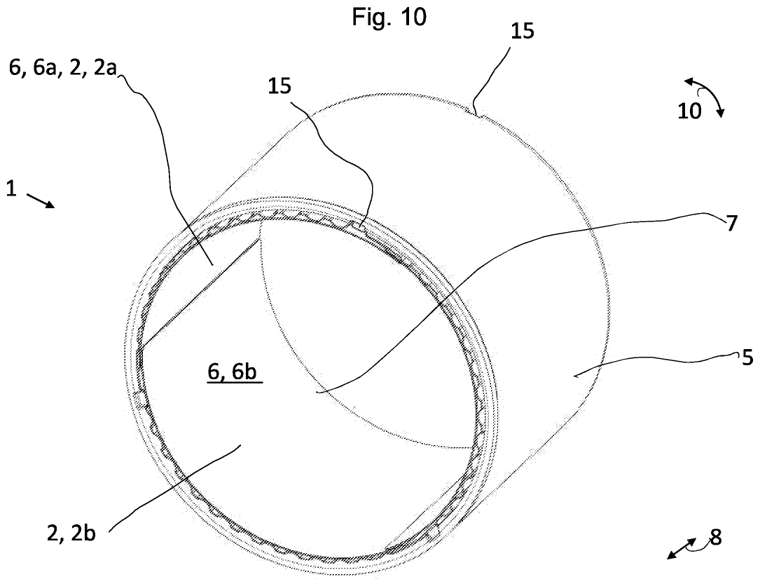

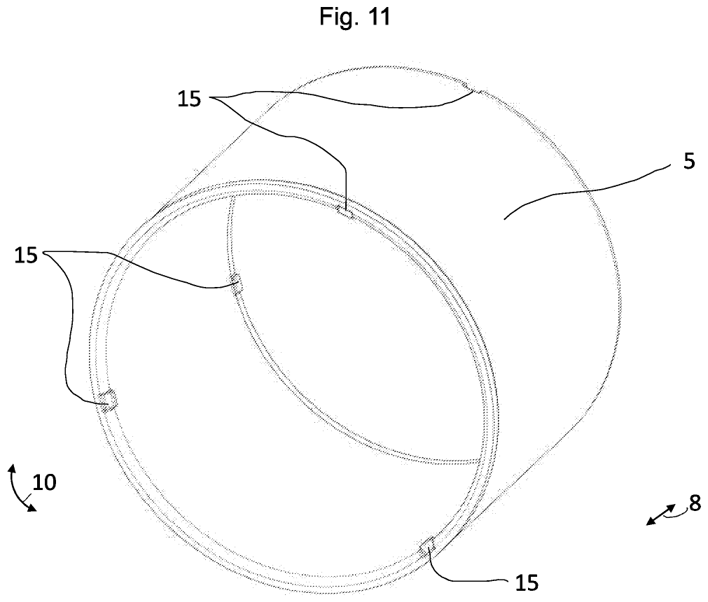

FIG. 10 shows a second variant of the outer ring 5 with the mounted tubular carrier 7. This outer ring 5 no longer has slots 12, but instead a plurality of material displacements 15, which are better illustrated in FIG. 11.

FIG. 11 shows the outer ring 5 for receiving a tubular carrier 7 according to FIG. 10. At its axial end, the outer ring 5 has material displacements 15 which lie opposite one another in the axial direction 8 and which have been formed from the material of the outer ring 5. These material displacements 15, which protrude radially inwards, fit into the notches 11, which are designed as positioning means, in the corrugated foil-like carrier foil 4 or the tubular carrier 7.

FIG. 12 shows a section in the axial direction 8 through the embodiment of FIG. 10. In addition to the rounded portions 13 and chamfers 14 of the outer ring 5 according to FIG. 7, the outer ring 5 can have these local and discrete material displacements 15.

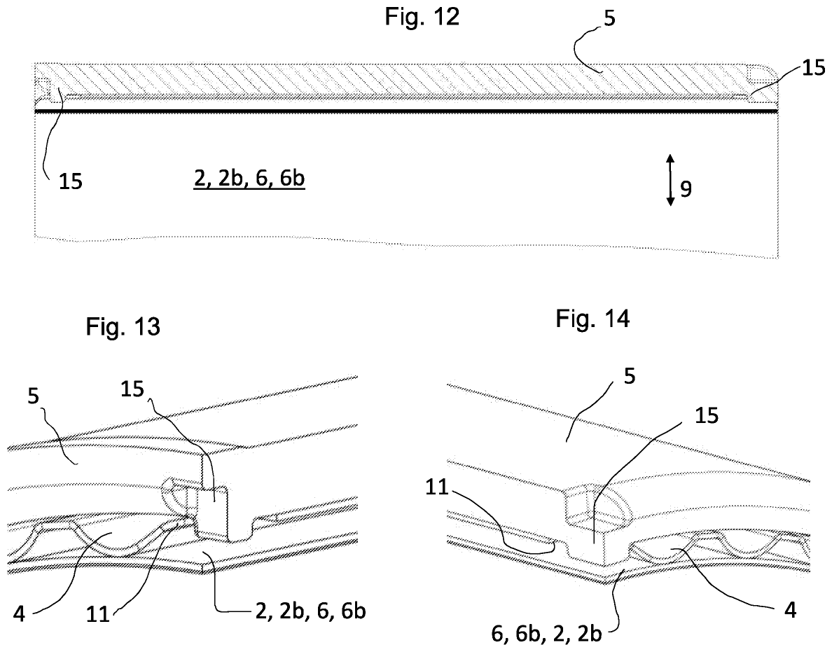

FIG. 13 shows a detailed view of the one axial end of the cut outer ring 5 according to FIG. 12. The radially inwardly directed material displacement 15 is formed by displacement of material of the outer ring 5 in the axial direction at a specific position and engages in a notch 11 of the carrier foil 4 to secure the position of the tubular carrier 7 in the circumferential direction 10 and in the axial direction 8. At least one degree of freedom of the tubular carrier 7 relative to the outer ring 5 is blocked here.

FIG. 14 shows a detailed view of the other axial end of the cut outer ring 5 according to FIG. 12. At the (other) end of the outer ring 5 opposite the one axial end of the outer ring 5 according to FIG. 13 in the axial direction 8, the material of the outer ring 5 is displaced inward in the radial direction and forms a material displacement 15 directed radially inward on this axial side of the outer ring 5, which also engages in a notch 11 of the corrugated foil-like carrier foil 4, in order to additionally secure the position of the tubular carrier 7 in the circumferential direction 10 and in the axial direction 8 and to block further degrees of freedom of the tubular carrier 7 in relation to the outer ring 5.

It is also conceivable as an alternative to the embodiment according to FIG. 12 that either the embodiment of the material displacement 15 according to FIG. 13 or the embodiment of the material displacement 15 according to FIG. 14 is arranged at both axial ends of the outer ring 5.

The material displacements 15 can ideally already have been introduced before the assembly of the outer ring 5 with the tubular carrier 7 in order not to damage the foil arrangements of the curved segments 6a, 6b, 6c during the displacement process. The tubular carrier 7 is so flexible in its shape that it can be inserted into the outer ring 5 without any problems.

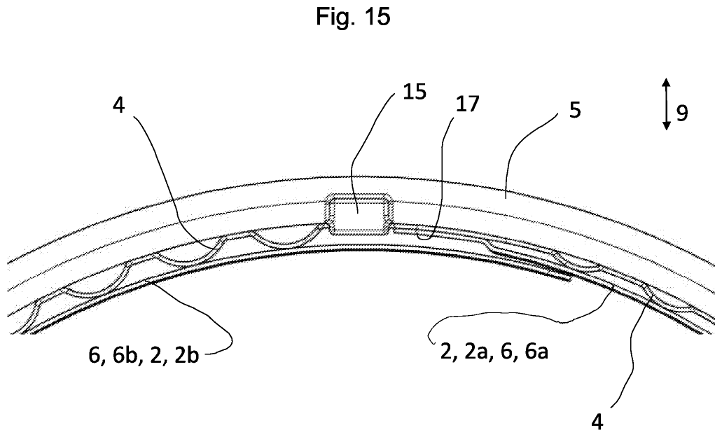

FIG. 15 shows a detailed view of the radial foil bearing 1. The rectangular material displacement 15 is clearly visible, which is formed by axially pushing a tool into the material of the outer ring 5 in such a way that a material displacement 15 directed radially inwards is produced.

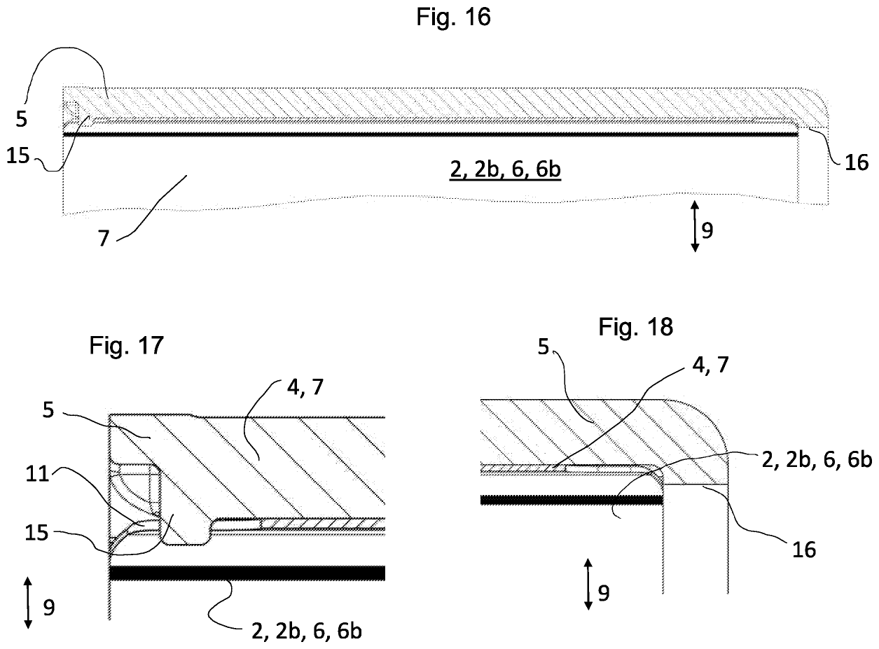

FIG. 16 shows a section in the axial direction 8 through the embodiment according to FIG. 15. The annular collar 16 which runs circumferentially in the circumferential direction 10 is clearly visible as an alternative to the discrete formation of local material displacements 15 in order to form a stop here during the assembly of the tubular carrier 7 in the outer ring 5. A radial overlap of the annular collar 16 with the foils of the tubular carrier 7 at least in the thickness of the corrugated foil-like carrier foil 4 is already sufficient to block a degree of freedom of the tubular carrier 7 in an axial direction since the curved segments 6a to 6c with the corrugated foil-like carrier foil 4 are welded and are wrapped by the corrugated foil-like carrier foil 4.

FIG. 17 shows a detailed view of one axial end of the cut outer ring 5 according to FIG. 15. The material displacement 15 engages in the notch 11 and secures the tubular carrier 7 in the circumferential direction 10 and also in an axial direction 8. The material displacement 15 protrudes in the radial direction 9 into the notch 11.

FIG. 18 shows a detailed view of the other axial end of the cut outer ring 5 according to FIG. 15. The annular collar 16 secures the tubular carrier 7 only in an axial direction 8. Securing in the circumferential direction 10 is not provided.

### REFERENCE NUMERALS

1 Radial foil bearing
2 Top foil
2a First top foil
2b Second top foil
2c Third top foil
4 Corrugated foil-like carrier foil
5 Outer ring
6 Curved segment
6a First curved segment
6b Second curved segment
6c Third curved segment
7 Tubular carrier
8 Axial direction
9 Radial direction
10 Circumferential direction
11 Notch
12 Slot
13 Rounded portion
14 Chamfer
15 Material displacement
16 Annular collar
17 Weld

1. A radial foil bearing having at least one top foil and at least one corrugated foil, wherein:
the top foil and the corrugated foil are constructed one on top of the other in the radial direction and said foils in the circumferential direction form at least one curved segment of the radial foil bearing,
a first curved segment is formed from a first top foil,
the first curved segment (a) is fixedly arranged on a carrier foil,
on the carrier foil a second curved segment is formed from a second top foil,
the two curved segments are placed successively on said carrier foil so that, when the carrier foil is rolled up, a tubular carrier with the two curved segments is produced and forms the radial foil bearing, and
the carrier foil is designed as a corrugated foil.

2. The radial foil bearing according to claim 1, wherein:
a third curved segment is formed with a third top foil, and
the three curved segments, each consisting of a top foil, are arranged successively on the corrugated foil-like carrier foil such that, when the carrier foil is rolled up, the tubular carrier with the three curved segments is produced and forms the radial foil bearing.

3. The radial foil bearing according to claim 1, wherein the number of curved segments and the successive arrangement thereof on a corrugated foil-like carrier foil can be scaled.

4. The radial foil bearing according to claim 1, wherein, after the corrugated foil-like carrier foil has been rolled up to form a tubular carrier with the curved segments, the tubular carrier has a circumferential closed shape, and the two ends of the corrugated foil-like carrier foil face each other.

5. The radial foil bearing according to claim 1, wherein, after the corrugated foil-like carrier foil has been rolled up to form a tubular carrier with the curved segments, one end of one curved segment is opposite the end of a subsequent curved segment.

6. The radial foil bearing according to claim 4, wherein the opposite ends contact one another.

7. The radial foil bearing according to claim 4, wherein the opposite ends are spaced from one another.

8. The radial foil bearing according to claim 4, wherein, after the corrugated foil-like carrier foil has been rolled up to form a tubular carrier, the successive top foils overlap so as to touch at their ends in the radial direction.

9. The radial foil bearing according to claim 1, wherein the annular carrier is inserted into an outer ring to form the radial foil bearing.

10. The radial foil bearing according to claim 8, wherein the outer ring is a separate component which, with the tubular carrier, forms the radial foil bearing which can be inserted into a housing, or the outer ring is formed by the housing itself, in which the tubular carrier can be inserted to form the radial foil bearing.

11. The radial foil bearing according to claim 8, wherein a degree of freedom in the axial direction of the tubular carrier which is placed in the outer ring is blocked.

12. The radial foil bearing according to claim 8, wherein a degree of freedom in the circumferential direction of the tubular carrier which is placed in the outer ring is blocked.

13. A radial foil bearing, comprising:
a carrier foil formed from a corrugated foil;
a first curved segment formed from a first top foil; and
a second curved segment formed from a second top foil, the second curved segment arranged successively on the carrier foil after the first curved segment to form a tubular carrier comprising two curved segments when the carrier foil is rolled.

14. The radial foil bearing of claim 13, further comprising a third curved segment formed from a third top foil, wherein the third curved segment is arranged successively on the carrier foil after the second curved segment to form a tubular carrier comprising three curved segments when the carrier foil is rolled.

15. The radial foil bearing of claim 13, wherein:
the carrier foil comprises a first end and a second end; and
after the carrier foil is rolled to form the tubular carrier, the tubular carrier has a circumferentially closed shape and the first end faces the second end.

16. The radial foil bearing of claim 15, wherein:
the first end contacts the second end; or
the first end is spaced apart from the second end.

17. The radial foil bearing of claim 13, wherein the first curved segment overlaps at least a portion of the second curved segment when the carrier foil is rolled.

18. The radial foil bearing of claim 13 further comprising an outer ring, wherein the tubular carrier is inserted into the outer ring.

19. The radial foil bearing of claim 17 wherein:
the tubular carrier comprises a notch; and
the outer ring comprises a material displacement disposed in the notch to restrict axial or circumferential displacement of the tubular carrier relative to the outer ring.
